(19) United States
(12) Patent Application Publication
(10) Pub. No.: US 2026/0276136 A1
(43) Pub. Date: Sep. 17, 2026

(54) COAXIAL DRIVE MODULE CAPABLE OF MOTION AND FORCE CONTROL

(71) Applicant: DAEGU GYEONGBUK INSTITUTE OF SCIENCE AND TECHNOLOGY, Daegu (KR)

(72) Inventors: Se Hoon OH, Daegu (KR); Da Sol CHEON, Gyeongsan-si (KR)

(73) Assignee: DAEGU GYEONGBUK INSTITUTE OF SCIENCE AND TECHNOLOGY, Daegu (KR)

(21) Appl. No.: 19/472,892

(22) PCT Filed: Mar. 12, 2024
(86) PCT No.: PCT/KR2024/003138

§ 371 Date: Oct. 6, 2025

(30) Foreign Application Priority Data
Apr. 7, 2023 (KR) 10-2023-0045854

(51) Int. Cl. F16M 11/18; F16M 11/04; F16M 11/22

(52) U.S. Cl. CPC F16M 11/18; F16M 11/045; F16M 11/22

(57) ABSTRACT

The coaxial drive module capable of motion and force control includes a first drive configured to provide a first driving force about a drive shaft; a second drive coaxially connected to the drive shaft and configured to be interlocked with the first driving force or to provide a second driving force different from the first driving force; and an output unit configured to receive and output the first and second driving forces, wherein the first driving force includes a linear driving force with respect to the output unit to adjust a position of an object output by the output unit, and the second driving force includes an elastic driving force with respect to the output unit to adjust a magnitude of force output by the output unit.

### CROSS REFERENCE TO RELATED APPLICATIONS

This is a National Stage Application of International Application No. PCT/KR2024/003138 filed Mar. 12, 2024, claiming priority based on Patent Application No. 10-2023-0045854 filed Apr. 7, 2023.

### STATEMENT REGARDING FEDERALLY SPONSORED RESEARCH OR DEVELOPMENT

This work was supported by the National Research Foundation of Korea(NRF) grant funded by the Korea government(MSIT) (No. RS-2024-00354028), the Institute of Information & Communications Technology Planning & Evaluation(IITP) grant funded by the Korea government(MSIT) (No. RS-2025-02219277, Al Star Fellowship Support (DGIST)), and the Institute of Information & Communications Technology Planning & Evaluation(IITP) grant funded by the Korea government(MSIT) (No. RS-2025-02219277, Al Star Fellowship Support (DGIST)).

### TECHNICAL FIELD

The present invention relates to a coaxial drive module capable of motion and force control, and more particularly, to a coaxial drive module capable of motion and force control in which a magnitude of force output and movement of a target object can be simultaneously controlled by sharing a single drive shaft.

### BACKGROUND ART

Generally, a drive device converts rotational power generated from a motor into linear power for transmission by using a ball screw and a nut. In such a general drive device, a ball screw connected to the motor is rotated by the rotational power, and a nut moves along threads of the rotating ball screw, thereby converting the rotational power into linear power.

Meanwhile, in the case of a drive device that converts rotational power into linear power using a ball screw and a nut, it is advantageous for adjusting a position of the nut according to a thread pitch of the ball screw, but it is not easy to adjust a magnitude of driving force. Various drive devices have been proposed for adjusting the magnitude of the driving force; however, implementing both position adjustment of the nut and magnitude adjustment of the driving force simultaneously may cause another problem, such as an increase in the size of the drive device.

Accordingly, in recent years, there has been a continuous demand for research on various drive devices for improving driving efficiency through adjustment of both the position of the nut and the magnitude of the driving force output from the drive device.

### DETAILED DESCRIPTION OF THE INVENTION

### Technical Problem

An object of the present invention is to provide a coaxial drive module capable of motion and force control, in which adjustment of a position of an output object and a magnitude of force is simultaneously possible by sharing a single shaft.

### Technical Solution

In order to achieve the above object, a coaxial drive module capable of motion and force control according to the present invention comprises: a first drive configured to provide a first driving force about a drive shaft, a second drive coaxially connected to the drive shaft and configured to be interlocked with the first driving force or to provide a second driving force different from the first driving force, and an output unit configured to receive and output the first and second driving forces,
wherein the first driving force includes a linear driving force with respect to the output unit to adjust a position of an object output by the output unit, and the second driving force includes an elastic driving force with respect to the output unit to adjust a magnitude of force output by the output unit.

The second drive may be configured to detect an elastic deformation displacement of the second driving force caused by an external force and to adjust the second driving force.

The first drive may comprise: a first drive source configured to generate the first driving force about the drive shaft, a coupling member shaft-connected to a drive shaft of the first drive source and configured to transmit the first driving force of the first drive source in a direction parallel to the drive shaft, a screw member coaxially connected to the drive shaft by the shaft connection to the coupling member and configured to be rotated by the first driving force, and a nut member configured to move in a linear direction parallel to the drive shaft along threads formed on an outer circumferential surface of the screw member in association with rotation of the screw member.

The first drive may further comprise a first sensor member configured to detect the linear movement of the output unit caused by the first driving force.

The second drive may comprise: a second drive source configured to generate the second driving force, a connection member connected to the nut member and configured to move in the linear direction along the screw member by the first or second driving force, a transmission member configured to transmit the second driving force of the second drive source to the connection member, at least one elastic member disposed between the connection member and the output unit, and a second sensor member configured to detect an elastic deformation displacement of the at least one elastic member.

The transmission member may comprise: a pulley configured to be linked with the connection member, and a belt disposed between the second drive source and the pulley to transmit the second driving force generated from the second drive source to the pulley.

The second sensor member may be movably disposed along a guide bar provided between the output unit and the connection member to detect the elastic deformation displacement of the at least one elastic member.

The output unit may comprise: at least one output member spaced apart from the connection member, and a connection block configured to support movement of the output member with respect to a support unit and to link the output member to movement of the second drive.

The connection member may be enclosed and protected by a housing and may be movable along the screw member together with the housing, and a bearing member may be provided between the connection member and the housing to block transmission of rotational force of the connection member, which is rotated along the screw member, to the housing.

The coaxial drive module may further comprise a support unit configured to support the first and second drives, wherein the support unit comprises: a support frame extending parallel to the drive shaft to support the first and second drives, at least one fixing member configured to fix an installation position of the first drive with respect to the support frame, and a guide rail provided on the support frame parallel to the drive shaft to guide linear movement of the second drive.

In another preferred aspect of the present invention, a coaxial drive module capable of motion and force control comprises: a first drive configured to provide a linear driving force about a drive shaft, a second drive coaxially connected to the drive shaft and configured to be interlocked with the linear driving force or to generate an elastic driving force, and an output unit connected to the second drive and configured to have a position of an object output by the linear driving force adjusted or a magnitude of force output by the elastic driving force adjusted, wherein when an elastic deformation displacement of the elastic driving force caused by an external force is detected, the second drive adjusts the elastic driving force.

The first drive may comprise: a first drive source configured to generate a first rotational force for the linear driving force, a coupling member shaft-connected to a drive shaft of the first drive source and configured to transmit the first rotational force of the first drive source in a direction parallel to the drive shaft, a screw member coaxially connected to the drive shaft by the shaft connection to the coupling member and configured to be rotated by the first rotational force of the first drive source, and a nut member configured to move in a linear direction parallel to the drive shaft along threads formed on an outer circumferential surface of the screw member in association with rotation of the screw member, wherein the nut member is connected to the second drive to linearly drive the second drive by the first rotational force of the first drive source to provide the linear driving force to the output unit.

The first drive may further comprise a first sensor member configured to detect movement of the output unit caused by the first rotational force of the first drive source.

The second drive may comprise: a second drive source configured to generate a second rotational force for the elastic driving force, a connection member connected to the nut member and configured to move in the linear direction along the screw member by the first and second rotational forces, a transmission member configured to transmit the second rotational force of the second drive source to the connection member, at least one elastic member disposed between the connection member and the output unit, and a second sensor member configured to detect an elastic deformation displacement of the at least one elastic member.

The transmission member may comprise: a pulley configured to be linked with the connection member, and a belt disposed between the second drive source and the pulley to transmit the second rotational force generated from the second drive source to the pulley.

The second sensor member may be movably disposed along a guide bar provided between the output unit and the connection member to detect the elastic deformation displacement of the at least one elastic member.

The output unit may comprise: at least one output member spaced apart from the connection member, and a connection block configured to support movement of the output member with respect to a support unit and to link the output member to movement of the second drive.

The connection member may be enclosed and protected by a housing and may be movable along the screw member together with the housing, and a bearing member may be provided between the connection member and the housing to block transmission of rotational force of the connection member, which is rotated along the screw member, to the housing.

The coaxial drive module may further comprise a support unit configured to support the first and second drives, wherein the support unit comprises: a support frame extending parallel to the drive shaft to support the first and second drives, at least one fixing member configured to fix an installation position of the first drive with respect to the support frame, and a guide rail provided on the support frame parallel to the drive shaft to guide linear movement of the second drive.

### Advantageous Effects

According to the present invention having the configuration as described above, it is possible to precisely adjust a position of an output object by sharing a single drive shaft, and it is also possible to adjust a magnitude of force in real time by detecting an elastic deformation displacement caused by an external force. As a result, a high-efficiency coaxial drive module capable of motion and force control, which enables high-speed and precise control due to simultaneous adjustment of the position and the magnitude of force of the object, can be provided.

In addition, it is possible to provide a coaxial drive module capable of motion and force control having a compact size that can share a single drive shaft in series rather than in parallel, which is advantageous for securing versatility of use.

### DESCRIPTION OF DRAWINGS

FIG. 1 is a perspective view schematically illustrating a coaxial drive module capable of motion and force control according to a preferred embodiment of the present invention.

FIG. 2 is a cross-sectional view schematically illustrating the coaxial drive module capable of motion and force control shown in FIG. 1, taken along line II-II thereof.

FIG. 3 is a perspective view schematically illustrating the coaxial drive module capable of motion and force control shown in FIG. 1 to explain an operating state thereof.

### BEST MODE

Hereinafter, a preferred embodiment of the present invention will be described with reference to the accompanying drawings. However, the spirit of the present invention is not limited to such an embodiment, and the spirit of the present invention may be proposed in different forms through addition, modification, or deletion of the components constituting the embodiment, which are also included in the spirit of the invention.

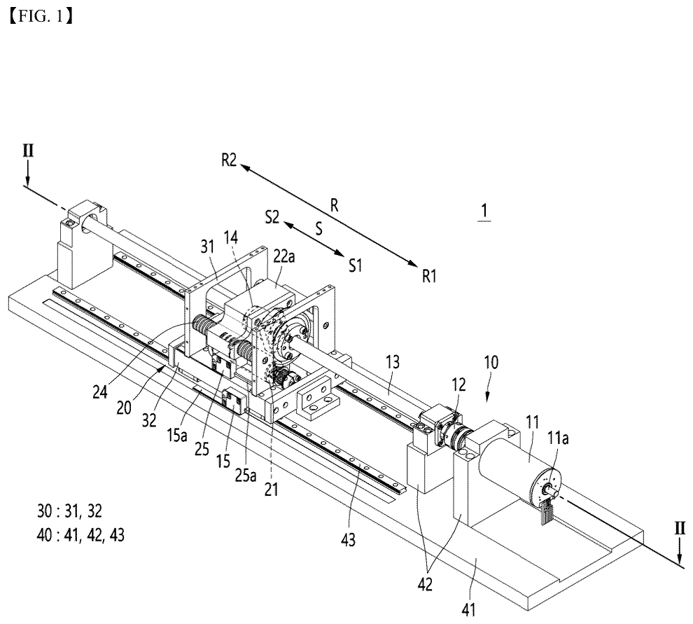

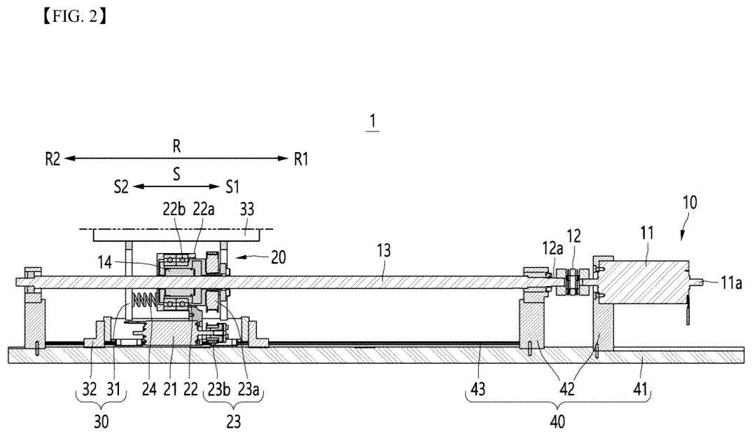

Referring to FIGS. 1 and 2, a coaxial drive module (1) capable of motion and force control according to a preferred embodiment of the present invention comprises a first drive (10), a second drive (20), an output unit (30), and a support unit (40).

For reference, FIG. 1 is a perspective view schematically illustrating the coaxial drive module (1) capable of motion and force control according to an embodiment of the present invention, and FIG. 2 is a cross-sectional view schematically illustrating the coaxial drive module (1) capable of motion and force control shown in FIG. 1.

The first drive (10) generates and transmits a first driving force about a drive shaft (11a). Here, the first drive (10) generates a first rotational force about the drive shaft (11a) to provide the first driving force, which is a linear driving force, in a linear direction (R). To this end, the first drive (10) comprises a first drive source (11), a coupling member (12), a screw member (13), a nut member (14), and a first sensor member (15).

The first drive source (11) generates the first rotational force about the drive shaft (11a) to provide the first driving force to the output unit (30) to be described later. Here, the first drive source (11) may include a motor configured to rotate the drive shaft (11a), but is not necessarily limited thereto.

The coupling member (12) is coupled to the drive shaft (11a) of the first drive source (11) and transmits the first driving force generated from the first drive source (11) in a direction parallel to the drive shaft (11a). The coupling member (12) has a coupling shaft (12a) shaft-connected to the drive shaft (11a). Here, one end of the coupling shaft (12a) is shaft-connected to the first drive shaft (11a), and the other end is shaft-connected to a screw member (13) to be described later.

As shown in FIG. 2, the screw member (13) is coaxially connected to the drive shaft (11a) by being shaft-connected to the coupling shaft (12a) of the coupling member (12). The screw member (13) is shaft-connected to the first drive source (11) via the coupling member (12), and thus is rotated about the drive shaft (11a) by the first driving force of the first drive source (11).

The nut member (14) is configured to move in a linear direction (R) parallel to the drive shaft (11a) along threads formed on an outer circumferential surface of the screw member (13) in association with rotation of the screw member (13). In this case, in reference to FIG. 1, the rightward direction of the linear direction (R) in which the nut member (14) moves is referred to as R1, and the leftward direction is referred to as R2. For reference, the nut member (14) is connected to a second drive (20) to be described later, such that the second drive (20) can be driven in the linear direction (R) by the first driving force.

The first sensor member (15) detects a driving range caused by the first driving force generated from the first drive source (11). The first sensor member (15) is provided in the output unit (30) driven by the first driving force, and measures a range of movement of the output unit (30) in the linear direction (R). At this time, the first sensor member (15) can measure the movement in the linear direction (R) through interference with a position guider (15a) provided in a support unit (40) to be described later.

For reference, the first drive (10) having the configuration as described above includes a type of rigid drive configured to provide the first driving force in the linear direction (R).

The second drive (20) is coaxially connected to the drive shaft (11a) and is configured to be interlocked with the first driving force or to generate a second driving force different from the first driving force and provide it to the output unit (30). Here, the second driving force includes an elastic driving force with respect to the output unit (30) to be described later. In addition, the second drive (20) can adjust a magnitude of force output by the second driving force including the elastic driving force by detecting an elastic deformation displacement of the elastic driving force caused by an external force. To this end, the second drive (20) comprises a second drive source (21), a connection member (22), a transmission member (23), an elastic member (24), and a second sensor member (25).

The second drive source (21) generates the second driving force. As described above, the second driving force may include the elastic driving force. The second drive source (21) provides the second driving force by generating a second rotational force about a rotation shaft (not shown). Meanwhile, like the first drive source (11), the second drive source (21) may include a motor capable of generating the second driving force by rotational force, but is not necessarily limited thereto.

The connection member (22) is connected to the nut member (14) of the first drive (10) and is configured to be movable in the linear direction (R) along the screw member (13). The connection member (22) may be provided in a shape configured to surround and support an outer circumferential surface of the nut member (14) so as to be rotatable about the screw member (13) with the nut member (14) therebetween. However, the present invention is not necessarily limited thereto, and it is apparent that the connection member (22) may be formed in any of various shapes on one side of the nut member (14).

The connection member (22) is enclosed and protected by a housing (22a). The connection member (22) is configured to be movable along the screw member (13) inside the housing (22a). However, the present invention is not necessarily limited thereto, and a modified example is also possible in which the connection member (22) is not enclosed and protected by the housing (22a) but is instead exposed directly to the outside.

Meanwhile, a bearing member (22b) including ball bearings is provided between the connection member (22) and the housing (22a) to block transmission of rotational force of the connection member (22), which is rotated along the screw member (13), to the housing (22a). As a result, even if the connection member (22) is rotated about the screw member (13) inside the housing (22a), the housing (22a) can maintain a posture of covering and protecting the connection member (22).

The transmission member (23) transmits the second driving force generated from the second drive source (21) to the connection member (22). The transmission member (23) may employ any of various driving force transmission means capable of being driven by the second driving force of the second drive source (21) to drive the connection member (22). In the present embodiment, as shown in FIG. 2, the transmission member (23) is exemplified as comprising a pulley (23a) and a belt (23b).

The pulley (23a) is configured to be linked with the connection member (22). As shown in FIG. 2, the pulley (23a) is provided on one side of the connection member (22) and is exemplified as being configured to be rotatable along threads of the screw member (13) together with the connection member (22) while being movable in the direction of the drive shaft (11a).

The belt (23b) is disposed between the second drive source (21) and the pulley (23a) to transmit the second driving force generated from the second drive source (21) to the pulley (23a). That is, when the second driving force is generated from the second drive source (21), the belt (23b) is rotated by the generated second driving force, and the pulley (23a) connected to the belt (23b) is rotated by rotation of the belt (23b) so that the connection member (22) can be rotated along the screw member (13).

The elastic member (24) is provided between the connection member (22) and the output unit (30) in at least one instance to elastically support the connection member (22) and the output unit (30). In the present embodiment, the elastic member (24) is exemplified as being provided in a pair; however, the number of installations and positions of the elastic member (24) are not limited to the illustrated example. In addition, the elastic member (24) is exemplified as a coil spring capable of being compressed and extended between the connection member (22) and the output unit (30), but is not necessarily limited thereto.

For reference, the elastic member (24) elastically supports the output unit (30) to be described later, and an elastic force of the elastic member (24) is adjusted by the second driving force of the second drive source (21).

The second sensor member (25) detects an elastic deformation displacement of the elastic member (24). The second sensor member (25) may detect that a distance between the connection member (22) and the output unit (30) with the elastic member (24) interposed therebetween is different from a preset value due to compression or extension of the elastic member (24), but is not necessarily limited thereto. In the present embodiment, the second sensor member (25) is exemplified as being movably provided along a guide bar (25a) disposed between the output unit (30) and at least one connection member (22) to detect an elastic deformation displacement of at least one elastic member (24) due to compression or extension thereof.

Meanwhile, when the elastic deformation displacement of the elastic member (24) detected by the second sensor member (25) deviates from a preset value, the second sensor member (25) feeds back the deviation to the second drive source (21). As a result, the second drive source (21) is driven so that the elastic deformation displacement of the deformed elastic member (24) is adjusted to the initial preset value. The adjustment of the elastic deformation displacement of the elastic member (24) by the second drive source (21) will be described in more detail later.

For reference, the second drive (20) having the configuration as described above includes a type of elastic drive configured to provide the second driving force in the elastic direction(S).

The output unit (30) receives and outputs the first and second driving forces generated from the first and second drives (10, 20). The output unit (30) comprises an output member (31) and a connection block (32).

The output member (31) is provided as at least one frame spaced apart from the connection member (22) with the elastic member (24) interposed therebetween. Here, the output member (31) may be driven in the linear direction (R) along the screw member (13) by receiving the first driving force of the first drive (10), or may be driven in the elastic direction(S) along the screw member (13) by receiving the second driving force from the second drive (20) via the elastic member (24). In this case, a target object (33) is provided on the pair of output members (31) so that the first and second driving forces of the first and second drives (10, 20) are output to the target object (33).

For reference, in the present embodiment, the output member (31) is illustrated and exemplified as being provided in a pair spaced apart from the connection member (22) with a pair of elastic members (24) interposed therebetween, but is not necessarily limited thereto. Here, a distance by which the output unit (30) is spaced apart from the connection member (22) corresponds to a range of the elastic driving force provided by the elastic member (24) to be described later.

The connection block (32) supports movement of the output member (31) with respect to the support unit (40) and links the output member (31) to movement of the second drive (20). The connection block (32) is a block configured to simultaneously support at least one output member (31), and in the present embodiment, the connection block (32) simultaneously supports the pair of output members (31). In addition, the connection block (32) may also simultaneously support the second drive (20) disposed between the pair of output members (31), and the connection block (32) may be supported by the support unit (40) to be described later so that its movement is guided.

For reference, the housing (22a) of the second drive (20) is provided in the connection block (32), so that the connection block (32) moves in the linear direction (R) in association with movement of the connection member (22) provided inside the housing (22a).

The support unit (40) supports the first and second drives (10, 20). The support unit (40) comprises a support frame (41), a fixing member (42), and a guide rail (43).

The support frame (41) is provided in a shape extending parallel to the drive shaft (11a) so as to support the first and second drives (10, 20). More specifically, the support frame (41) has a rod shape extending in the direction of the drive shaft (11a) along the screw member (13) extending in the direction of the drive shaft (11a) from the first drive (10).

The fixing member (42) is provided in at least one instance to fix an installation position of the first drive (10) with respect to the support frame (41). In the present embodiment, as illustrated in FIGS. 1 and 2, three fixing members (42) are exemplified as being provided with respect to the support frame (41). Each of the three fixing members (42) has a shape in which a central region is open by being penetrated through, so that the first drive source (11) and the screw member (13) are inserted into the open central region and fixed in position with respect to the support frame (41).

The guide rail (43) is provided on the support frame (41) parallel to the drive shaft (11a) to guide movement of the second drive (20) in the linear direction (R). The guide rail (43) extends in a longitudinal direction on the support frame (41) and is exemplified as being at least a pair. The second drive (20) and the output unit (30) are connected to the guide rail (43) so as to be movable along the screw member (13), thereby guiding movement of the second drive (20) and the output unit (30) along the guide rail (43).

Here, the guide rail (43) may have the connection block (32) inserted therein to support both the second drive (20) and the output member (31) simultaneously and to guide movement in the linear direction (R). For this purpose, when the guide rail (43) is provided as a pair, the connection block (32) inserted into the guide rail (43) may also be provided as a pair.

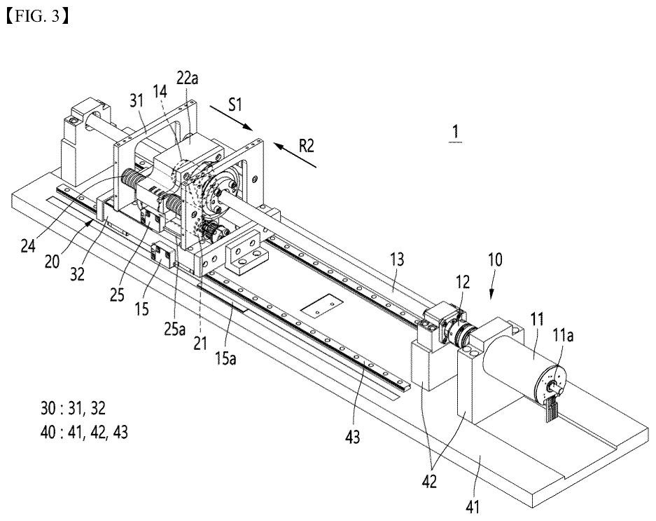

Hereinafter, a driving operation of a coaxial drive module (1) capable of motion and force control according to an embodiment of the present invention will be described with reference to FIG. 3.

As shown in FIG. 3, the first driving force generated from the first drive source (11) is coaxially transmitted to the coupling member (12) through the drive shaft (11a), and a coupling shaft (12a) of the coupling member (12) is coaxially connected to the screw member (13). As a result, the first driving force generated from the first drive source (11) is coaxially transmitted to the screw member (13), so that the screw member (13) is rotated about the drive shaft (11a).

By rotation of the screw member (13), a nut member (14) interposed on an outer circumferential surface of the screw member (13) moves in the linear direction (R) along threads of the screw member (13). In the present embodiment, the nut member (14) is exemplified as being linearly moved in the R2 direction shown in FIG. 3 by rotation of the screw member (13).

In association with movement of the nut member (14) in the R2 direction along the screw member (13), a connection member (22) of the second drive (20) provided on one side of the nut member (14) is also moved in the linear direction (R), that is, in the R2 direction. By the movement of the connection member (22) interlocked with the nut member (14), the second drive (20) including the connection member (22) is driven together in the linear direction.

In addition, since the housing (22a) enclosing and protecting the connection member (22) of the second drive (20) is provided in the connection block (32), the housing (22a) is moved in the R2 direction together with the connection block (32) in association with the movement of the second drive (20) in the R2 direction. As a result, the output member (31) provided in the connection block (32) is also driven in the R2 direction, so that the first driving force is ultimately output through the output member (31). Here, due to the nut member (14) being rotated along the threads formed on the outer circumferential surface of the screw member (13), a position of an object output to the output unit (30) can be precisely adjusted. At this time, the linear movement of the second drive (20) in the linear direction (R) by the first driving force of the first drive (10) can be detected by the first sensor member (15).

Meanwhile, when an external force is applied to at least one of the output unit (30) or the second drive (20), an elastic deformation displacement is generated by compression or extension of the elastic member (24). The elastic deformation displacement of the elastic member (24) is detected by the second sensor member (25) configured to detect a distance between the connection member (22) and the elastic member (24) in association with the connection member (22).

The elastic deformation displacement detected by the second sensor member (25) is fed back to the second drive source (21) of the second drive (20), so that the second drive source (21) generates an elastic driving force, that is, the second driving force, to compensate for the elastic deformation displacement caused by the external force. When the second driving force is generated from the second drive source (21), the second driving force is transmitted to the connection member (22) via the transmission member (23) including the pulley (23a) and the belt (23b), thereby rotating the connection member (22) to move the screw member (13) in the elastic direction(S). At this time, the connection member (22) is moved, for example, in the S1 direction in the elastic direction(S) for returning the elastic deformation displacement, along the threads formed on the outer circumferential surface of the screw member (13), so that the magnitude of force is adjusted such that the elastic deformation displacement of the elastic member (24) returns to “0 .” Here, when the second sensor member (25) detects that the elastic deformation displacement caused by the external force has returned to the initial state, generation of the second driving force by the second drive source (21) is stopped.

As described above, the first and second drives (10, 20) coaxially connected to the drive shaft (11a) can share a single drive shaft (11a) to provide a driving force in the linear direction (R) to the output unit (30), and can also compensate for the elastic deformation displacement caused by an external force using the second driving force. As a result, the position and magnitude of force of an object output from the compact-sized coaxial drive module (1) capable of motion and force control can be simultaneously adjusted.

As described above, although the preferred embodiment of the present invention has been described with reference to the foregoing, it will be understood by those skilled in the art that various modifications and changes can be made to the present invention without departing from the spirit and scope of the invention as set forth in the following claims.

### INDUSTRIAL APPLICABILITY

According to the present invention having the configuration as described above, it is possible to precisely adjust a position of an output object by sharing a single drive shaft, and it is also possible to adjust a magnitude of force in real time by detecting an elastic deformation displacement caused by an external force. As a result, a high-efficiency coaxial drive module capable of motion and force control, which enables high-speed and precise control due to simultaneous adjustment of the position and the magnitude of driving force of the object, can be provided.

In addition, it is possible to provide a compact-sized coaxial drive module capable of motion and force control in which a single drive shaft can be shared in series rather than in parallel, which is advantageous for securing versatility of use.

1. A coaxial drive module capable of motion and force control, comprising:
a first drive configured to provide a first driving force about a drive shaft;
a second drive coaxially connected to the drive shaft and configured to be interlocked with the first driving force or to provide a second driving force different from the first driving force; and
an output unit configured to receive and output the first and second driving forces,
wherein the first driving force includes a linear driving force with respect to the output unit to adjust a position of an object output by the output unit, and
wherein the second driving force includes an elastic driving force with respect to the output unit to adjust a magnitude of force output by the output unit.

2. The coaxial drive module of claim 1, wherein the second drive is configured to detect an elastic deformation displacement of the second driving force caused by an external force and to adjust the second driving force.

3. The coaxial drive module of claim 1, wherein the first drive comprises:
a first drive source configured to generate the first driving force about the drive shaft;
a coupling member shaft-connected to a drive shaft of the first drive source and configured to transmit the first driving force of the first drive source in a direction parallel to the drive shaft;
a screw member coaxially connected to the drive shaft by the shaft connection to the coupling member and configured to be rotated by the first driving force; and
a nut member configured to move in a linear direction parallel to the drive shaft along threads formed on an outer circumferential surface of the screw member in association with rotation of the screw member.

4. The coaxial drive module of claim 3, wherein the first drive further comprises a first sensor member configured to detect the linear movement of the output unit caused by the first driving force.

5. The coaxial drive module of claim 3, wherein the second drive comprises:
a second drive source configured to generate the second driving force;
a connection member connected to the nut member and configured to move in the linear direction along the screw member by the first or second driving force;
a transmission member configured to transmit the second driving force of the second drive source to the connection member;
at least one elastic member disposed between the connection member and the output unit; and
a second sensor member configured to detect an elastic deformation displacement of the at least one elastic member.

6. The coaxial drive module of claim 5, wherein the transmission member comprises:
a pulley configured to be linked with the connection member; and
a belt disposed between the second drive source and the pulley to transmit the second driving force generated from the second drive source to the pulley.

7. The coaxial drive module of claim 5, wherein the second sensor member is movably disposed along a guide bar provided between the output unit and the connection member to detect the elastic deformation displacement of the at least one elastic member.

8. The coaxial drive module of claim 5, wherein the output unit comprises:
at least one output member spaced apart from the connection member; and
a connection block configured to support movement of the output member with respect to a support unit and to link the output member to movement of the second drive.

9. The coaxial drive module of claim 5, wherein the connection member is enclosed and protected by a housing and is movable along the screw member together with the housing, and a bearing member is provided between the connection member and the housing to block transmission of rotational force of the connection member, which is rotated along the screw member, to the housing.

10. The coaxial drive module of claim 1, further comprising a support unit configured to support the first and second drives,
wherein the support unit comprises:
a support frame extending parallel to the drive shaft to support the first and second drives;
at least one fixing member configured to fix an installation position of the first drive with respect to the support frame; and
a guide rail provided on the support frame parallel to the drive shaft to guide linear movement of the second drive.

11. A coaxial drive module capable of motion and force control, comprising:
a first drive configured to provide a linear driving force about a drive shaft;
a second drive coaxially connected to the drive shaft and configured to be interlocked with the linear driving force or to generate an elastic driving force; and
an output unit connected to the second drive and configured to have a position of an object output by the linear driving force adjusted or a magnitude of force output by the elastic driving force adjusted,
wherein when an elastic deformation displacement of the elastic driving force caused by an external force is detected, the second drive adjusts the elastic driving force.

12. The coaxial drive module of claim 1, wherein the first drive comprises:
a first drive source configured to generate a first rotational force for the linear driving force;
a coupling member shaft-connected to a drive shaft of the first drive source and configured to transmit the first rotational force of the first drive source in a direction parallel to the drive shaft;
a screw member coaxially connected to the drive shaft by the shaft connection to the coupling member and configured to be rotated by the first rotational force of the first drive source; and
a nut member configured to move in a linear direction parallel to the drive shaft along threads formed on an outer circumferential surface of the screw member in association with rotation of the screw member,
wherein the nut member is connected to the second drive to linearly drive the second drive by the first rotational force of the first drive source to provide the linear driving force to the output unit.

13. The coaxial drive module of claim 12, wherein the first drive further comprises a first sensor member configured to detect movement of the output unit caused by the first rotational force of the first drive source.

14. The coaxial drive module of claim 12, wherein the second drive comprises:
a second drive source configured to generate a second rotational force for the elastic driving force;
a connection member connected to the nut member and configured to move in the linear direction along the screw member by the first and second rotational forces;
a transmission member configured to transmit the second rotational force of the second drive source to the connection member;
at least one elastic member disposed between the connection member and the output unit; and
a second sensor member configured to detect an elastic deformation displacement of the at least one elastic member.

15. The coaxial drive module of claim 14, wherein the transmission member comprises:
a pulley configured to be linked with the connection member; and
a belt disposed between the second drive source and the pulley to transmit the second rotational force generated from the second drive source to the pulley.

16. The coaxial drive module of claim 14, wherein the second sensor member is movably disposed along a guide bar provided between the output unit and the connection member to detect the elastic deformation displacement of the at least one elastic member.

17. The coaxial drive module of claim 14, wherein the output unit comprises:
at least one output member spaced apart from the connection member; and
a connection block configured to support movement of the output member with respect to a support unit and to link the output member to movement of the second drive.

18. The coaxial drive module of claim 14, wherein the connection member is enclosed and protected by a housing and is movable along the screw member together with the housing, and a bearing member is provided between the connection member and the housing to block transmission of rotational force of the connection member, which is rotated along the screw member, to the housing.

19. The coaxial drive module of claim 11, further comprising a support unit configured to support the first and second drives,
wherein the support unit comprises:
a support frame extending parallel to the drive shaft to support the first and second drives;
at least one fixing member configured to fix an installation position of the first drive with respect to the support frame; and
a guide rail provided on the support frame parallel to the drive shaft to guide linear movement of the second drive.
